(19) United States
(12) Patent Application Publication
(10) Pub. No.: US 2013/0163072 A1
(43) Pub. Date: Jun. 27, 2013

(54) MULTI-CORE OPTICAL FIBER, WAVELENGTH DIVISION MULTIPLEXING COUPLER, AND MULTI-CORE OPTICAL FIBER AMPLIFIER

(71) Applicants: Sun Hyok CHANG, Daejeon (KR); Hwan Seok CHUNG, Daejeon (KR)

(72) Inventors: Sun Hyok CHANG, Daejeon (KR); Hwan Seok CHUNG, Daejeon (KR)

(73) Assignee: Electronics and Telecommunications Research Institute, Daejeon (KR)

(21) Appl. No.: 13/609,951

(22) Filed: Sep. 11, 2012

(30) Foreign Application Priority Data
Dec. 26, 2011 (KR) 10-2011-0142608

(51) Int. Cl. H01S 3/067; G02B 6/26; G02B 6/036

(52) U.S. Cl. 359/341.3; 385/126; 385/39

(57) ABSTRACT

The multi-core optical fiber amplifier according to an exemplary embodiment of the present invention having the above configuration includes: a double clad multi-core optical fiber including a plurality of cores, an internal cladding enclosing the plurality of cores, and an external cladding enclosing the internal cladding; a pumping light source outputting pumping light; an optical fiber to which pumping light from the pumping light source is input; and a wavelength division multiplexing coupler coupling the optical fiber with the double clad multi-core optical fiber to apply the pumping light input to the optical fiber from the pumping light source to the double clad multi-core optical fiber.

### CROSS-REFERENCE TO RELATED APPLICATIONS

This application claims priority to and the benefit of Korean Patent Application No. 10-2011-0142608 filed in the Korean Intellectual Property Office on Dec. 26, 2011, the entire contents of which are incorporated herein by reference.

### TECHNICAL FIELD

The present invention relates to a multi-core optical fiber, a wavelength division multiplexing coupler using the same, a multi-core optical fiber, and more particularly, to a multi-core optical fiber having a simple structure and using a small number of pumping light sources, a wavelength division multiplexing coupler, and a multi-core optical fiber amplifier.

### BACKGROUND ART

As shown in FIG. 1, a general optical fiber is configured to include a cladding 101 and a core 102. FIG. 1 shows a vertical cross-sectional shape to a longitudinal direction of an optical fiber. The cladding and the core are basically formed of SiO₂ and are slightly doped with additives (Ge, Al, or the like), thereby increasing and reducing a refractive index. The core is manufactured to have higher refractive index than that of the cladding. The propagation of light power of optical signals is limited to the core and proceeds along a longitudinal direction of the optical fiber. In addition, the number of transverse modes of the propagated optical signal can be controlled by a difference in size, diffraction index, or the like, of the core. The optical fiber used for optical communications is divided into a single mode fiber and a multi-mode fiber and one mode may proceed to the single mode optical fiber or at least two modes may proceed to the multi-mode optical fiber. Generally, in order to transmit the optical signal relatively farther, the single mode optical fiber is used.

With the development of Internet, and the like, data traffic has been increased very rapidly and a demand for long-distance optical transmission has been greatly increased accordingly. As a result, transmission capacity that can transmit data using the single mode optical fiber has reached a saturation state. In order to solve this, a multi-core optical fiber as shown in FIG. 2 has been developed recently. FIG. 2 shows a vertical cross section shape to the longitudinal direction of the multi-core optical fiber. Referring to FIG. 2, the multi-core optical fiber is configured to a cladding 201 and a plurality of cores 202. When using the multi-core optical fiber, the optical signal can be transmitted using each core and therefore, the transmission capacity can be increased in response to the number of cores. However, the transmission using the multi-core optical fiber is in an early stage of research and includes many problems to be solved in future. One of the important problems to be solved is the very multi-core optical fiber amplifier.

The optical signal is attenuated while passing through the optical fiber. Therefore, in order to compensate for loss, an optical amplifier is used. An erbium-doped fiber amplifier (EDFA) using an erbium-doped fiber can obtain an optical gain in a wavelength band of 1530 to 1610 nm and has been prevalently used in optical transmission systems.

FIG. 3 shows an example of a multi-core optical fiber amplifier that can be manufactured by a current technology. An erbium-doped optical fiber 301 disclosed in “Amplification and noise properties of an erbium-doped multicore fiber amplifier”, Optics Express, Vol. 19, No. 17, pp. 16715 (2011) is manufactured by a multi-core scheme. The erbium-doped optical fiber shown in FIG. 3 is manufactured by a multi-core method. The multi-core erbium-doped optical fiber basically has a structure as shown in FIG. 2 and can obtain an optical gain by doping the core with erbium. As optical fibers 302 and 317 used as a transmission path, the multi-core optical fiber has also been used. Multi-core optical fiber connectors 303 and 316 bond the multi-core optical fibers of both ends thereof using a connector. Fiber bundled couplers 304, 308, 311, and 315 are devices that connect respective cores of the multi-core optical fiber with each other so as to be bonded with the single core optical fiber. The fiber bundled couplers 304, 308, 311, and 315 are configured to connect the multi core optical fibers each having 7 cores to 7 single core optical fibers. Reference numerals 305, 307, 312, and 314 of FIG. 3 each show a connecting portion of the single core optical fiber. For the connecting thereof, the single core optical fiber connector or fiber splicing are used. Reference numerals 309 and 310 of FIG. 3 shows a connecting portion of the multi-core optical fiber and the erbium-doped multi-core optical fiber, which may be connected by the multi-core optical fiber connector or the fiber splicing.

In order to obtain the optical gain using the erbium-doped optical fiber, there is a need to perform optical pumping using light sources having different wavelengths. Reference numerals 318 and 319 of FIG. 3 each show 7 pumping light sources. Outputs of each pumping light sources are configured to apply pumping light to each core using 7 WDM couplers 306 and 313. Like a pumping light source direction of reference numeral 318 of FIG. 3, the case in which the propagation direction of the optical signal is the same as the that of the pumping light is referred to as forward pumping and like a pumping light source direction of reference numeral 319 of FIG. 3, the case in which the propagation direction of the optical signal is opposite to the that of the pumping light is referred to as backward pumping. One of the two pumpings may be used. As described above, the optical signal passing through the optical line of the multi-core optical fiber 302 of FIG. 3 is separated into each of the single core optical fiber by the filter bundled coupler 304 and is again combined at the bonding portion of reference numeral 308 and then, passes through the multi-core erbium-doped optical fiber 301.

As described above, the multi-core optical fiber amplifier according to the related art uses several fiber bundled couplers 304, 308, 311, and 315, several pumping light sources 318 and 319, WDM couplers 306 and 313, and the like, and thus, has a very complicated structure. The major cause of the foregoing configuration is that the WDM couplers 306 and 313 that combine the outputs of the pumping light source with the signal light are configured of the single core optical fiber. In addition, it is impossible to manufacture the WDM couplers using the multi-core optical fiber having the structure shown in FIG. 2.

### SUMMARY OF THE INVENTION

The present invention has been made in an effort to provide a multi-core optical fiber, a wavelength division multiplexing coupler, and a multi-core optical fiber amplifier capable of using a smaller number of pumping light sources while simplifying a structure.

An exemplary embodiment of the present invention provides a multi-core optical fiber including: a plurality of cores, an internal cladding enclosing the plurality of cores, and an external cladding enclosing the internal cladding, and a refractive index of the core is larger than that of the internal cladding and a refractive index of the internal cladding is larger than that of the external cladding.

Yet another exemplary embodiment of the present invention provides a wavelength division multiplexing coupler for an optical fiber, including: a first area corresponding to a single clad single core optical fiber and including a core area and a cladding area enclosing the core area; and a second area corresponding to a double clad multi-core optical fiber and including a plurality of core areas, an internal cladding area enclosing the plurality of core areas, and an external cladding area enclosing the internal cladding area, wherein a diameter of the core area in the first area is larger than that of the core area in the second area.

Still another exemplary embodiment of the present invention provides a multi-core optical fiber amplifier, including: a double clad multi-core optical fiber configured to include a plurality of cores, an internal cladding enclosing the plurality of cores, and an external cladding enclosing the internal cladding; a pumping light source configured to output pumping light; an optical fiber configured to receive pumping light from the pumping light source; and a wavelength division multiplexing coupler configured to couple the optical fiber with the double clad multi-core optical fiber to apply the pumping light input to the optical fiber from the pumping light source to the double clad multi-core optical fiber.

The multi-core optical fiber and the multi-core optical fiber amplifier according to the present invention as described above can use the small number of pumping light sources while simplifying the structure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional view showing a vertical cross section shape to a longitudinal direction to a general optical fiber according to the related art.

FIG. 2 is a cross-sectional view showing a vertical cross section shape to a longitudinal direction to a general multi-core optical fiber according to the related art.

FIG. 3 is a diagram showing an example of a multi-core optical fiber amplifier according to the related art.

FIG. 4 is a cross-sectional view showing a double clad multi-core optical fiber according to an exemplary embodiment of the present invention.

FIG. 5 is a cross-sectional view showing an example of a WDM coupler using a double clad multi-core optical fiber according to the exemplary embodiment of the present invention.

FIGS. 6 to 8 are diagrams showing an example of the double clad multi-core optical fiber amplifier according to the exemplary embodiment of the present invention.

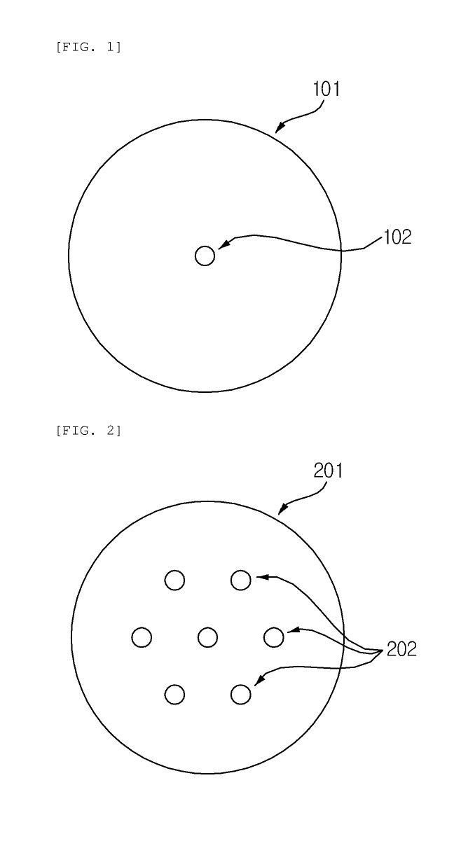

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a multi-core optical fiber, a wavelength division multiplexing coupler, and a multi-core optical fiber amplifier according to exemplary embodiments of the present invention will be described with reference to the accompanying drawings.

The multi-core optical fiber according to the exemplary embodiment of the present invention includes a plurality of cores, an internal cladding enclosing the plurality of cores, and an external cladding enclosing the internal cladding, wherein a refractive index of the core is larger than that of the internal cladding and a refractive index of the internal cladding is larger than that of the external cladding.

A wavelength division multiplexing coupler according to the exemplary embodiment of the present invention includes: a first area corresponding to a single clad single core optical fiber and including a core area and a cladding area enclosing the core area; and a second area corresponding to a double clad multi-core optical fiber and including a plurality of core areas, an internal cladding area enclosing the plurality of core areas, and an external cladding area enclosing the internal cladding area, wherein a diameter of the core area in the first area is larger than that of the core area in the second area.

The multi-core optical fiber amplifier according to the exemplary embodiment of the present invention includes: a double clad multi-core optical fiber including a plurality of cores, an internal cladding enclosing the plurality of cores, and an external cladding enclosing the internal cladding; a pumping light source outputting pumping light; an optical fiber to which pumping light from the pumping light source is input; and a wavelength division multiplexing coupler coupling the optical fiber with the double clad multi-core optical fiber to apply the pumping light input to the optical fiber from the pumping light source to the double clad multi-core optical fiber.

The multi-core optical fiber, the wavelength division multiplexing coupler, and the multi-core optical fiber amplifier according to the exemplary embodiment of the present invention having the foregoing configuration will be separately described below.

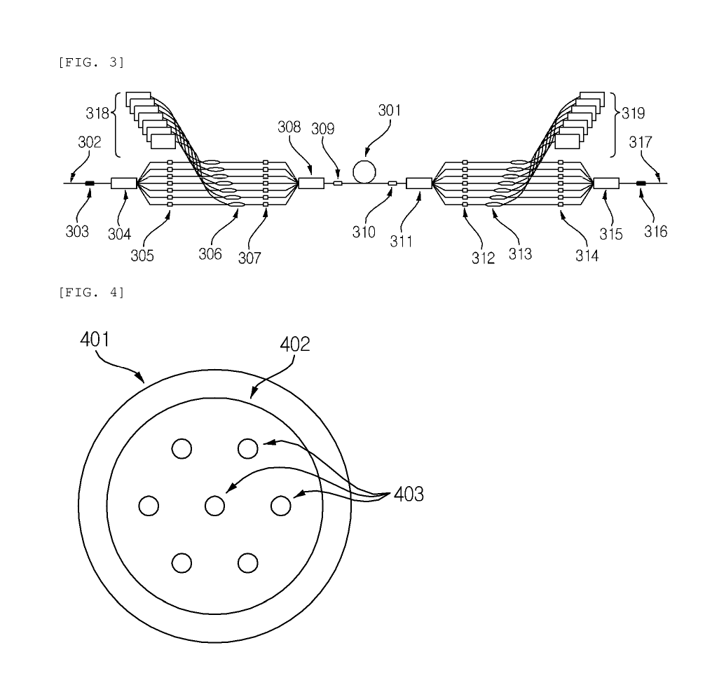

FIG. 4 is a cross-sectional view of a double clad multi-core optical fiber according to an exemplary embodiment of the present invention. Referring to FIG. 4, the double clad multi-core optical fiber is configured to include an external cladding 401, an internal cladding 402, and a core 403.

FIG. 4 shows the double clad multi-core optical fiber having 7 cores, which is for convenience of explanation. The present invention is not limited thereto and the number of cores of the double clad multi-core optical fiber according to the present invention may be sufficiently changed according to the design and manufacturing method.

In components of the double clad multi-core optical fiber shown in FIG. 4, the core has the largest refractive index, the external cladding has the smallest refractive index, and the internal cladding has the refractive index between the core and the external cladding.

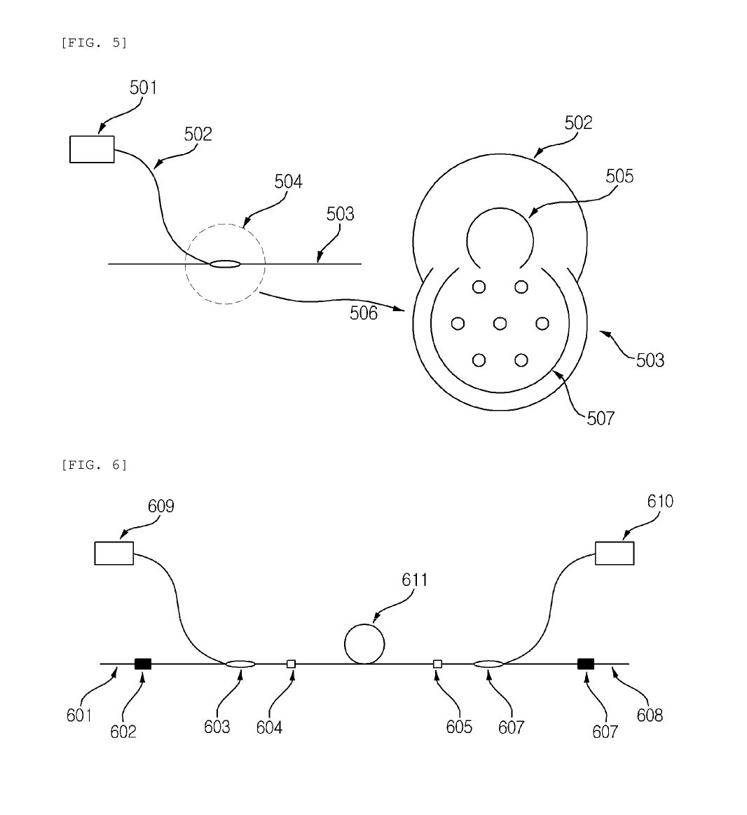

FIG. 5 shows the WDM (pumping light/signal light) coupler using the double clad multi-core optical fiber as shown in FIG. 4.

In FIG. 5, an output of a pumping light source 501 passes through the optical fiber 502 and the optical fiber 502 is coupled with the double clad multi-core optical fiber 503 through a wavelength division multiplexing coupler 504. In this case, a configuration of the double clad multi-core optical fiber 503 is shown in FIG. 4.

A cross section of the WDM coupler 504 that couples the optical fiber 502 with the double clad multi-core optical fiber 503 is the same as reference number 506 of FIG. 5. The foregoing WDM coupler 504 may be melting bonded using tapering or an outer portion of the WDM coupler 504 may be grounded by grinding so as to bond the optical fiber 502 to the double clad multi-core optical fiber 503.

The optical fiber 502 of the pumping light source 501 needs to have a core 505 having a relatively larger size than the double clad multi-core optical fiber 503, which is to easily apply high light power. The pumping light passing through the core 505 of the optical fiber 502 is propagated to the internal cladding 507 by being coupled with the internal cladding 507 of the double clad multi-core optical fiber 503. In this case, an effective refractive index at the core 505 and an effective refractive index of the internal cladding 507 need to be similar or equal to each other. The pumping light may be applied to the multi-core optical fiber 503 by the above scheme. The pumping light may be propagated to the internal cladding of the double clad multi-core optical fiber 503 to pump the core portion.

The multi-core optical fiber amplifier as shown in FIG. 6 can be configured using the WDM coupler as shown in FIG. 5.

Multi-core optical fibers 601 and 608 as shown in FIG. 6 are used as the transmission path and are connected with the multi-core optical fiber amplifier by multi-core optical fiber connectors 602 and 607.

The multi-core optical fiber amplifier is configured to include WDM couplers 603 and 606, pumping light sources 609 and 610, and a double clad multi-core erbium-doped optical fiber 611.

The WDM couplers 603 and 606 have a structure as shown in FIG. 5 and are configured to easily apply the light power of the pumping light sources 609 and 610. Reference numerals 604 and 605 of FIG. 6 are a bonding portion of the double clad multi-core erbium-doped optical fiber 611 and the multi-core optical fibers 601 and 608 and may be bonded with each other by the multi-core optical fiber connector, the fiber splicing, and the like. The pumping light applied through the WDM couplers 603 and 606 is easily applied to the double clad multi-core erbium-doped optical fiber 611 and therefore, the configuration of the amplifier can be simplified.

The double clad multi-core erbium-doped optical fiber 611 may basically have the same structure as FIG. 4 and may also have the structure as shown in FIG. 2. Each core is doped with erbium. The present invention describes the erbium-doped optical fiber as an example, but may sufficiently use the optical fiber doped with other materials other than erbium if the optical amplification can be implemented.

Comparing FIG. 6 showing the embodiment of the present invention with FIG. 3 showing the related art, it can be appreciated that the multi-core optical fiber amplifier according to the embodiment of the present invention does not need to include the fiber bundled coupler (304, 308, 311, and 315 of FIG. 3) in order to separate or couple the multi-core optical fiber from or to several single core optical fibers and it can be appreciated that the number of pumping light sources can remarkably reduced and thus, the structure is very simple.

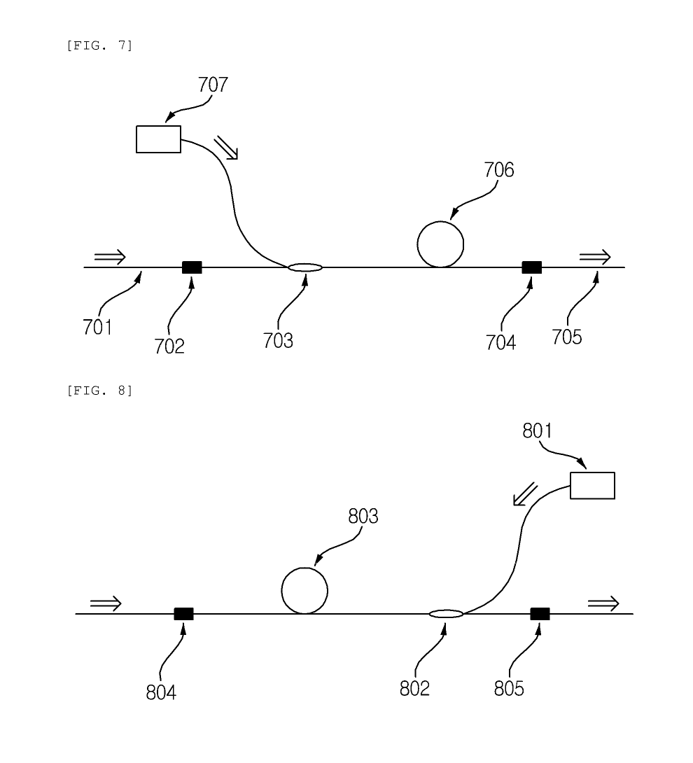

Unlike FIG. 6, FIG. 7 shows the case of using only forward pumping. Multi-core optical fibers 701 and 705 as shown in FIG. 7 are used as the transmission path and are connected with the multi-core optical fiber amplifier by multi-core optical fiber connectors 702 and 704. The multi-core optical fiber amplifier is configured to include a WDM coupler 703, a pumping light source 707, and a double clad multi-core erbium-doped optical fiber 706. Pumping light from the pumping light source 707 is applied to the multi-core erbium-doped optical fiber 706 through the WDM coupler 603.

FIG. 8 shows a case of using only backward pumping. Pumping light from a pumping light source 801 is applied to a multi-core erbium-doped optical fiber 803 through a WDM coupler 802.

Likewise the case of FIG. 6, comparing the multi-core optical fiber amplifier shown in FIGS. 7 and 8 with the related art, it can be appreciated that the multi-core optical fiber amplifier does not need to include the fiber bundled couplers 304, 308, 311, and 315 of FIG. 3 separating or coupling the optical fiber from or with several single core optical fibers and the number of pumping light sources is remarkably reduced and the structure is very simple.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A multi-core optical fiber amplifier, comprising:
a double clad multi-core optical fiber configured to include a plurality of cores, an internal cladding enclosing the plurality of cores, and an external cladding enclosing the internal cladding;
a pumping light source configured to output pumping light;
an optical fiber configured to receive pumping light from the pumping light source; and
a wavelength division multiplexing coupler configured to couple the optical fiber with the double clad multi-core optical fiber to apply the pumping light input to the optical fiber from the pumping light source to the double clad multi-core optical fiber.

2. The multi-core optical fiber amplifier of claim 1, wherein the double clad multi-core optical fiber has the core doped with erbium.

3. The multi-core optical fiber amplifier of claim 1, wherein a diameter of the core of the optical fiber is larger than that of the core of the double clad multi-core optical fiber.

4. The multi-core optical fiber amplifier of claim 1, wherein a refractive index of the core of the double clad multi-core optical fiber is larger than that of the internal cladding thereof and a refractive index of the internal cladding is larger than that of the external cladding.

5. The multi-core optical fiber amplifier of claim 1, wherein an effective refractive index of the core of the optical fiber is the same as that of the internal cladding of the double clad multi-core optical fiber.

6. The multi-core optical fiber amplifier of claim 1, wherein the pumping light source include a first pumping light source outputting first pumping light and a second pumping light source outputting second pumping light,
the optical fiber includes a first optical fiber receiving the pumping light from the first pumping light source and a second optical fiber receiving the pumping light from the second pumping light source, and
the wavelength division multiplexing coupler includes a first wavelength division multiplexing coupler applying first pumping light input to the first optical fiber from the first pumping light source to the double clad multi-core optical fiber and a second wavelength division multiplexing coupler applying second pumping light input to the second optical fiber from the second pumping light source to the double clad multi-core optical fiber.

7. A multi-core optical fiber, comprising:
a plurality of cores;
an internal cladding enclosing the plurality of cores; and
an external cladding enclosing the internal cladding,
wherein a refractive index of the core is larger than that of the internal cladding and a refractive index of the internal cladding is larger than that of the external cladding.

8. A wavelength division multiplexing coupler for an optical fiber, comprising:
a first area corresponding to a single clad single core optical fiber and including a core area and a cladding area enclosing the core area; and
a second area corresponding to a double clad multi-core optical fiber and including a plurality of core areas, an internal cladding area enclosing the plurality of core areas, and an external cladding area enclosing the internal cladding area,
wherein a diameter of the core area in the first area is larger than that of the core area in the second area

9. The wavelength division multiplexing coupler for an optical fiber of claim 8, wherein the double clad multi-core optical fiber includes a plurality of cores, an internal cladding enclosing the plurality of cores, and an external cladding enclosing the internal cladding, and a refractive index of the core of the double clad multi-core optical fiber is larger than that of the internal cladding thereof and a refractive index of the internal cladding is larger than that of the external cladding.

10. The wavelength division multiplexing coupler for an optical fiber of claim 8, wherein the double clad multi-core optical fiber includes a plurality of cores, an internal cladding enclosing the plurality of cores, and an external cladding enclosing the internal cladding, and an effective refractive index of the core of the single core optical fiber is the same as that of the internal cladding of the double clad multi-core optical fiber.
